(19) United States
(12) Patent Application Publication
(10) Pub. No.: US 2005/0107114 A1
(43) Pub. Date: May 19, 2005

(54) Multi-user mobile telephone

(76) Inventor: Timothy John Ocock, London (GB)

Correspondence Address: Richard C. Woodbridge, Esq.;Synnestvedt Lechner & Woodbridge, LLP, P.O. Box 592, Princeton, NJ, 08542-0592, US

(21) Appl. No.: 10/953,850

(22) Filed: Sep. 29, 2004

(30) Foreign Application Priority Data
Sep. 29, 2003 (GB) 0322716.2

(51) Int. Cl. H04M 1/00; H04B 1/38

(52) U.S. Cl. 455/550.1; 455/566

(57) ABSTRACT

A mobile telephone is designed to be used by several different end-users at different times. A first end-user can alter the mobile telephone so that it operates in a manner specific to that first end-user and a subsequent end-user can alter the mobile telephone so that it operates in a manner specific to that subsequent end-user; each end-user has only to respond to prompts displayed on a screen in order to alter the mobile telephone so that it operates in a manner specific to that end-user.

### BACKGROUND OF THE INVENTION

1. Field of the Invention

This invention relates to a multi-user mobile telephone; i.e. a mobile telephone that is not personal to a single user but instead can readily be used by several people.

2. Description of the Prior Art

Mobile telephones are, conventionally, personal devices, to be used by a single individual. In part, this is because of the portable nature of the device; fixed, wire based phones are of course not personal devices at all but meant for multiple users.

Customisation of mobile telephone functionality is well known: for example, different decorative covers for mobile telephones can, through an IC embedded into the cover, alter the way that the telephone operates, perhaps enabling/disabling different funtions. However, this approach still assumes that the mobile telephone is a single user, personal device.

It is also possible to swap the SIM card in a mobile telephone; this approach again assumes that the mobile telephone is, at any one time, a single user, personal device.

In many developing countries, mobile phones are an expensive luxury item, and yet community programs are making them available to the very poorest people, who do not even have access to fixed phones. For example, in India, senior village members sell “time share” on the village mobile phone, and make a small profit on the calls that they can use to buy more phones over time.

### SUMMARY OF THE INVENTION

The present invention is a mobile telephone designed to be used by several different end-users at different times, in which a first end-user can alter the mobile telephone so that it operates in a manner specific to that first end-user and a subsequent end-user can alter the mobile telephone so that it operates in a manner specific to that subsequent end-user;
wherein each end-user has only to respond to prompts displayed on the telephone in order to alter the mobile telephone so that it operates in a manner specific to that end-user.

The present invention therefore moves away from the established assumption that a mobile telephone is personal to a single end-user and instead readily allows the mobile telephone to be used by several end-users through appropriate on-screen prompts. Such a device may be especially relevant to communities where few individuals can afford the cost of their own personal telephone. More generally, it is useful for any entity to whom there are benefits from being able to easily share mobile telephones across multiple end-users (e.g. large corporation may have a pool of such mobile telephones; any employee can then simply pick up one of these telephones and be able to use it like a personal device).

### BRIEF DESCRIPTION OF THE DRAWINGS

The present invention will be describe with reference to the accompanying drawings, which depict screens from a mobile telephone in accordance with the present invention.

### DETAILED DESCRIPTION

The present invention is a mobile telephone designed to be used by several different end-users at different times, in which a first end-user can alter the mobile telephone so that it operates in a manner specific to that first end-user and a subsequent end-user can alter the mobile telephone so that it operates in a manner specific to that subsequent end-user. Each end-user has only to respond to prompts displayed on the telephone in order to alter the mobile telephone so that it operates in a manner specific to that end-user.

The prompts may be part of an access control interaction. For example, the end-user could enter identifying information (e.g. a PIN) into the mobile telephone or, using a PIN, gain access to a menu of names of end-users displayed on the device so that he can then select his name from the menu. This is very different from having to physically alter the device, for example, by changing the SIM card. The prompts could also simply be a menu list of end-user names, visible to anyone (or at least anyone able to enter a shared PIN needed to activate the telephone).

The first end-user is typically the phone and outgoing connection/line's ‘manager’ or ‘controller’, whether as part of a commercial phone services' time sharing operation, or whether just as the responsible adult in a family responsible for the agreement with the service provider.

Each end-user can, on the same mobile telephone, have one or more of the following applications or functions specific to himself/herself:
Address book (this can be achieved by having a single address book database that is filtered, or by having individual databases that are swapped in and out as different users are swapped in and out)
Messages (including emails and instant messages)
Access controlled to games and applications
Record of time used (for billing purposes)
Indication of who incoming calls are for (if the phone application acts as a menu driven “receptionist”)—using for example different names, ringing tones, and photographs to identify both the incoming caller and the callee.
Use of (and log in details for) Internet services such as voice over internet, email, ecommerce (such as Amazon, eBay user ids using independent cookie databases) and mobile web browsing.

A separate application usable only by the ‘manager’ of the phone/line would be used to show reports and summaries of usage of voice and data and messaging services for billing purposes. It could also show booked offline time, and which applications were run and for how long, to support charging for gameplaying or other offline activities.

The database for storing the logs can be stored securely using data security features of the host platform. This prevents the users from being able to forge any of their usage data and could also offer them protection for being overcharged by records by the phone's owner.

Due to the nature of such a device, it is not suitable for incoming calls unless at prearranged times or unless it can pre-screen calls and identify who the call is for. This could be supported by a time booking application that could send messages to the caller telling them what time to call based on what time has been booked. In all other cases, incoming calls would be dealt with by a Voicemail like service, with messages either being:
Recorded onto paper by the “manager” of the phone and passed on
Integration of the multi user feature with the voice mail service, so each user has a separate voice mail account (with a menu driven multi-user mailbox as mentioned above for screening incoming calls)
An application on the phone that manages voicemails, including the ability to download the messages (by recording the call to voicemail) and sorting them into mailboxes for the different users of the phone.

The end-user could be an individual, or a family, or any other kind of social or commercial entity. Hence, in a developing country, different families might each choose to have their own family ‘profile’ on the village mobile telephone. Any family member can then select that family profile; the telephone then allows access to/displays that family's address book, messages for members of that family etc. Note that this is not the same as swapping the SIM card in a mobile telephone: preferably, the mobile telephone has a single SIM card, which is shared by all of the different end-users. The SIM card's primary purpose is to identify the charging between the local ‘manager’ and the network. Changing the end-user would be as simple as changing the profile from Meeting to Silent is now, with the option of a password for privacy purposes: e.g. a simple menu list of available end-users.

There could also be a concept of shared data, for common applications and common phone book entries. If only one contacts database is kept in the device memory, then the SIM card's limited address book could be used to store only those numbers needed by every user.

Where more than one phone is available in the community, profiles could be stored in a remote web service or on a nearby PC that connects via Bluetooth or other local bearers. The connectivity suite backup and restore mode could be used to switch users in and out. Each user could store their phone numbers and other settings on a memory card like an SD card, which when inserted in the phone allows the specific user's preferences, in terms of contacts, messages or other data to be loaded and available. A token on the memory card could be used to securely identify the particular user for purposes of managing the billing of voice or data calls.

The phone's login can pair with one or more web service's login, saving multiple redundant logins. Remembering logins for web services could potentially mean that there is a single login for the phone (which could be as simple as entering a SIM PIN number for single user phones).

Where a PC is used to offer Internet access through the phone, multi-user profiles could allow simultaneous use of a phone for voice calls and as a Bluetooth GPRS modem for a nearby PC user in any device where the hardware configuration or operating system features allow simultaneous use of the voice call and packet data modem functions.

This could be used in any mobile phone. Primarily, it could be used in any phone intended for developing world markets. Any mobile phone could be adapted to support most of these concepts purely with changes to the software.

Specifically in order to keep the cost low, these would not be specially designed phones with limited production runs. Rather, it would be possible to add the additional software using the device's built in software installation function. This application would have the following features:
User interface for switching between users. Either a passcode/PIN for each user would be needed, or only the owner of the phone, again identifying themselves with a unique passcode/PIN, would have the capability to change the user.
Enhanced log that tags each chargeable item (calls made, messages sent) with a unique identifier for the respective user.
The enhanced functionality for the incoming calls would consist of the ability to answer the phone and play a prerecorded message over the call, receive DTMF key presses from the caller to identify a particular user's mailbox, and allow recording of calls (by digital compression) as a voicemail function. Accessing the messages locally on the phone will be logged and could be a chargeable service. It's not impossible that these messages could even also be accessed remotely by dialling in and entering a special code and PIN to activate playback of the messages, allowing the mobile to be used as a locally and remotely accessible voicemail service.

The other changes necessary would be minimal and allow both normal and multi-user modes of operation. Specifically the following changes would enable the multi-user functionality without breaking the existing functionality:
Ability to change different contacts databases depending on the current user. Different databases could be stored in different files, or in a larger file and simply filtered to show contacts tagged as being accessible by the current user.
Ability to log calls made, messages sent, packet data traffic sent and other activities and to store this data securely so that it can be read but not changed, although deletion after a period of time is still possible. Such a log could use the device's existing log, but would require a feature to add additional information to each entry—specifically some unique identification of the user in each case. This could be achieved on such devices where the existing logging feature didn't support this, by the installed multi-user application.
Ability to log time spent using a particular application (such as a game) and securely store in the same manner as above.
Ability to remotely access said database to allow the services to be remotely administered—making it easier for the owner to manage more than one phone, perhaps through a web page interface. This would also allow remote administration of services such as pay-per-play game rental where the game is delivered over the air/over the internet and charged per instance or time period of use rather than simply as a one time fee on delivery.

Computer operating systems support multiple user log-ins for time sharing of CPU resources and for data security. The concept here is not to have a multi user operating system in that sense. The idea is that the phone features can be shared, not the “computer” features.

Currently mobile phone security revolves around the SIM card, which stores the subscription data and personal data like the address book. There is potential for someone to develop a module that could support one subscription but multiple user profiles. A suitably sophisticated and designed mobile phone uses the expanded memory of the device for storing of phone numbers and other settings of the particular user, so the SIM card and its built-in limited memory is used to manage only the subscription with the network provider, and the account of the phone “manager” (the administrator of the service).

The present invention has great potential in increasing the affordability of mobile telephones and hence their global proliferation: in parts of Kenya, for example, individuals cannot afford $100 for a mobile phone, but a whole family could if they clubbed together, but they would only do so if they could all fairly share the device and it's capabilities.

And in the developed world, it is hard to justify buying mobile phones for young children, limiting the market for integrated games devices, unless small children can share one device, and just use it for emergency calls when they go out of the house.

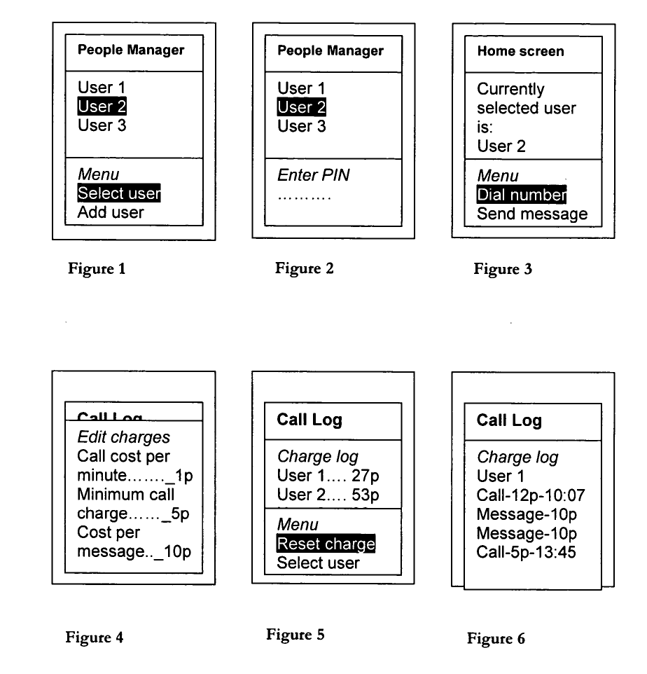

Referring now to the accompanying Figures, FIG. 1 shows how the end-users (e.g. members of the community or family that can use the telephone) appear on a menu when the phone is not being used or is in the control of the owner (i.e. User 1 would be the name of an end-user; User 2 the name of another end-user). New users can be added by the owner.

FIG. 2 shows that User 2 has been selected and that a PIN number has to be entered to allow the mode to change. FIG. 3 is the screen shown after a correct PIN has been entered by User 2: this makes User 2 active; he can choose to call numbers, send messages, play games etc.

FIG. 4 shows the screen that enables the ‘owner’/‘manager’ of the mobile telephone to edit the charges associated with each type of service. Normal users are not able to edit this table of course. In FIG. 5, the owner can see the current bills for each user, and also reset their tallys when they have paid. A break down of all the charges can be shown, as depicted in FIG. 6. The current user can also see his own call log, but not that of others.

1. A mobile telephone designed to be used by several different end-users at different times, in which a first end-user can alter the mobile telephone so that it operates in a manner specific to that first end-user and a subsequent end-user can alter the mobile telephone so that it operates in a manner specific to that subsequent end-user;
wherein each end-user has only to respond to prompts displayed on a screen in order to alter the mobile telephone so that it operates in a manner specific to that end-user.

2. The mobile telephone of claim 1 which allows an end-user to enter identifying information or gain access to a menu of names of end-users displayed on the device so that it can then select its name from the menu.

3. The mobile telephone of claim 1 in which the prompts are part of an access control interaction.

4. The mobile telephone of claim 1 which uses a single SIM card, which is shared by all of the different end-users.

5. The mobile telephone of claim 1 in which each end-user can have the following application or function of the mobile telephone specific or personal to itself: Address book.

6. The mobile telephone of claim 1 in which each end-user can have the following application or function of the mobile telephone specific or personal to itself: Messages.

7. The mobile telephone of claim 1 in which each end-user can have the following application or function of the mobile telephone specific or personal to itself: Access control to games and applications

8. The mobile telephone of claim 1 in which each end-user can have the following application or function of the mobile telephone specific or personal to itself: Record of time used (for billing purposes).

9. The mobile telephone of claim 1 in which each end-user can have the following application or function of the mobile telephone specific or personal to itself: Indication of who incoming calls are for.

10. The mobile telephone of claim 1 in which each end-user can have the following application or function of the mobile telephone specific or personal to itself: Use of (and log in details for) Internet services such as voice over internet, email, and mobile web browsing.

11. The mobile telephone of claim 1 in which the end-user is an individual, or a family, or any other kind of social or commercial entity.

12. The mobile telephone of claim 1 which stores and displays data that is common to several end-users.

13. The mobile telephone of claim 2 in which the access control process also serves as the access control process for a web service.

14. The mobile telephone of claim 1 further programmed with an application that can show reports and summaries for each end-user of one or more of the following for billing purposes:
(i) usage of voice and data and messaging services;
(ii) offline time;
(iii) which applications were run and for how long to support charging for gameplaying or other offline activities.

15. The mobile telephone of claim 14 further programmed to generate a database for storing the reports and summaries which is then securely stored.

16. The mobile telephone of claim 1 in which incoming calls are handled by a voice mail service.
